(19) United States
(12) Patent Application Publication
(10) Pub. No.: US 2006/0011787 A1
(43) Pub. Date: Jan. 19, 2006

(54) Outdoor cooking helping hand

(76) Inventor: David P. Law, Avondale, AZ (US)

Correspondence Address: David P. Law, 11025 Crimson Lane, Avondale, AZ, 85323, US

(21) Appl. No.: 10/835,866

(22) Filed: Jul. 13, 2004

(51) Int. Cl. F16L 3/00

(52) U.S. Cl. 248/121

(57) ABSTRACT

In summary this invention, the “Outdoor Cooking Helping Hand,” is designed to be a lightweight, portable, freestanding outdoor cooking utensil holder that provides the user with a convenient, clean, and organized system with stable footing, easy height adjustment, and paper towels right at hand.

### BACKGROUND OF INVENTION

In March of 2001 I, David P. Law, then of Larwill, Ind., while standing beside a campfire one evening, envisioned the “Outdoor Cooking Helping Hand” cooking setup.

I began developing the idea and continued forward, refining it to the present day conception.

The “Outdoor Cooking Helping Hand” idea was taken to a company called Invention Technologies who helped me to register the invention in the Disclosure Document Program #492737 for a period of two (2) years.

During this two (2) year period the invention—the “Outdoor Cooking Helping Hand”—was refined into the utensil stand it is today.

On Apr. 28, 2003 the invention—the “Outdoor Cooking Helping Hand”—was granted a provisional patent No. 60/465,491. During the year granted by the provisional patent research has produced enough information to prove this invention worthy of production and distribution. At this time a full patent is being applied for.

### DESCRIPTION OF DRAWINGS

The accompanying drawings further describe the invention “Outdoor Cooking Helping Hand.”

FIG. 1/8 is a conception drawing of an assembled utensil stand with paper towel roll and utensils.

FIG. 2/8 depicts the components of the collapsible arms constructed in accordance with the invention.

FIG. 3/8 shows a top view of the drawings on FIG. 2/8 and also shows a side view of the complete utensil arm including the notch hole for the floating double utensil hook. It also has a side view of the floating double utensil hook.

FIG. 4/8 shows the components and mechanics of the tripod base.

FIG. 5/8 is a top, or overhead, view of FIG. 4/8. It also shows the complete views of the leg pivots.

FIG. 6/8 depicts the internal locking height device as well as the guide sleeve.

FIG. 7/8 shows a sectioned view of the internal locking height device seen on FIG. 6/8.

FIG. 8/8 depicts the side and top views of the paper towel holder.

### DETAILED DESCRIPTION OF THE INVENTION

Outdoor cooking can mean juggling around utensils while seeking a clean surface to place them on while they are not in use.

An organized working area can prove indispensable to safe and efficient food preparation.

The “Outdoor Cooking Helping Hand” has been designed to lend a hand to outdoor cooks. It is a lightweight, portable, freestanding outdoor cooking utensil holder that provides the outdoor cook with a convenient, clean, and organized system with stable footing, easy height adjustment, and paper towels right at hand.

A description of each part and the construction of this utensil stand, the “Outdoor Cooking Helping Hand,” is as follows:

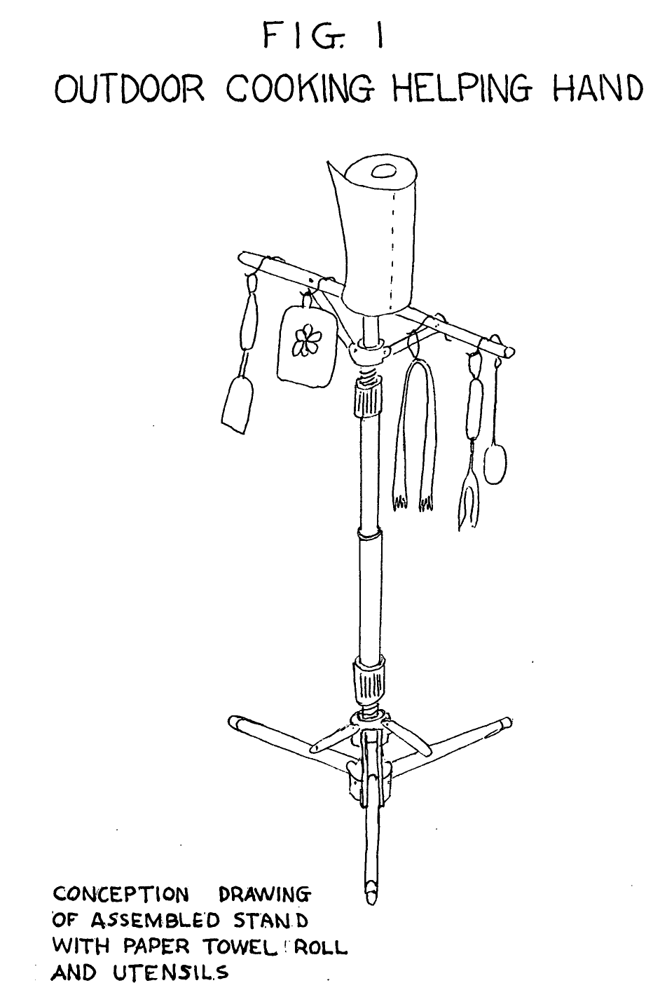

FIG. 1/8 shows a conception drawing of an assembled stand with a paper towel roll and cooking utensils.

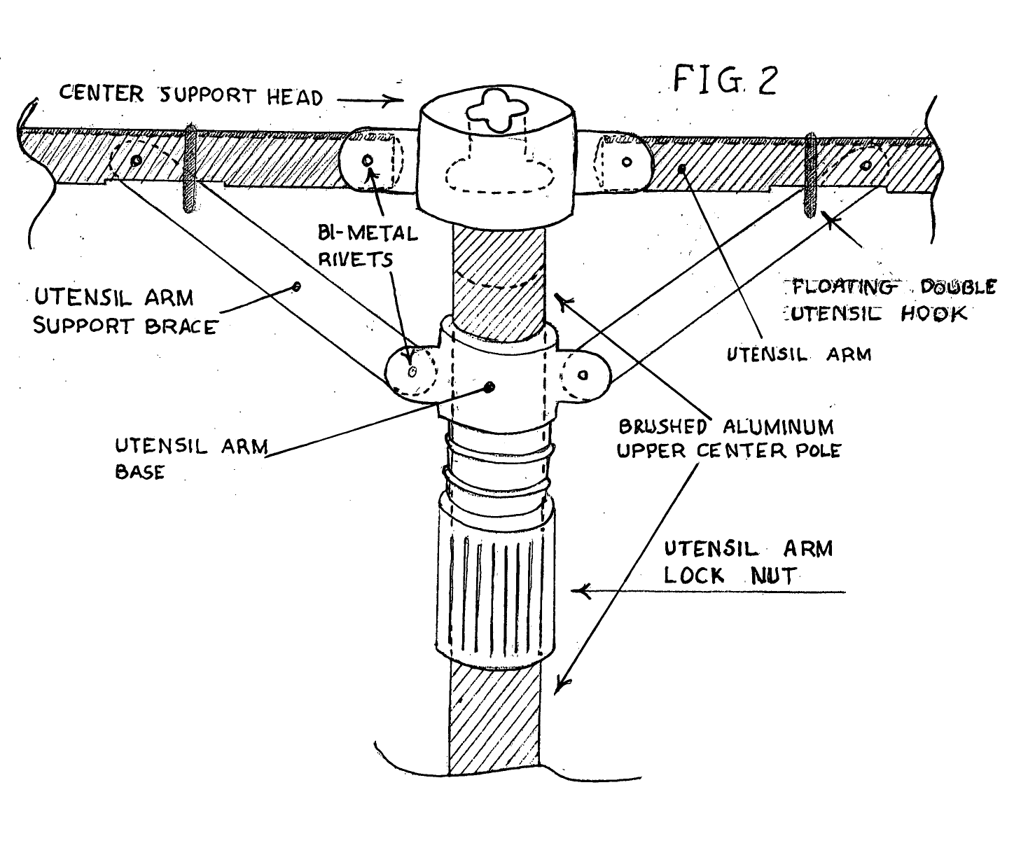

FIG. 2/8 shows the center support head. Preferred materials for construction of this center support head are steel, stainless steel, aluminum, brass, copper, glass, pot metal, lead, wood, vinyl, pewter, acrylic, ceramic, nickel, and all other metal alloys. The most preferred material for the center support head is injection molded plastic.

Connected to the center support head are the two (2) utensil arms (one on either side). The preferred materials for making these utensil arms are steel, stainless steel, injection molded plastic, PVC tube, brass, copper, glass, pot metal, lead, wood, vinyl, pewter, acrylic, ceramic, nickel, and all other metal alloys. The most preferred material for making a utensil arm is brushed aluminum tubing.

This brushed aluminum utensil arm is fitted with a set of four (4) double utensil hanging hooks. Preferred materials for construction of utensil hanging hooks are steel, aluminum, brass, copper, glass, pot metal, lead, wood, vinyl, pewter, acrylic, ceramic, nickel, and all other metal alloys. The most preferred material for utensil hanging hooks is stainless steel.

The utensil arm with the stainless steel floating hooks is held in place and supported by a utensil arm support brace (one on each arm).

The preferred materials for making a utensil arm support brace are steel, stainless steel, aluminum, brass, copper, glass, pot metal, lead, wood, vinyl, pewter, acrylic, ceramic, nickel, and all other metal alloys. The most preferred material for the utensil arm support brace is injection molded plastic.

The utensil arm support brace is fastened on one end to the utensil arm and the other end is fastened to the utensil arm base. The utensil arm base is a sleeve that slides up and down making it the movable part of the upper body. It anchors the head unit together and is what allows the unit to open and close.

Preferred materials for construction of the utensil arm base are steel, stainless steel, aluminum, brass, copper, glass, pot metal, lead, wood, vinyl, pewter, acrylic, ceramic, nickel, and all other metal alloys. The most preferred material for making a utensil arm base is injection molded plastic.

The utensil arms, utensil arm support brace, and utensil arm base are all joined together with bi-metal rivets to provide strength and flexibility for folding.

The upper center pole is the main support of the whole upper body of this utensil hanger unit. The preferred materials for making an upper center pole are steel, stainless steel, injection molded plastic, PVC tube, brass, copper, glass, pot metal, lead, wood, vinyl, pewter, acrylic, ceramic, nickel, and all other metal alloys. The most preferred material for the upper center pole is brushed aluminum tubing.

The pieces that comprise this head unit are locked into place once opened or closed by the utensil arm lock nut. Once the head unit is moved to the desired position the utensil arm lock nut is turned clockwise to a snug tightness to lock the utensil arm base into position.

The preferred materials for making a utensil arm lock nut are steel, stainless steel, aluminum, brass, copper, glass, pot metal, lead, wood, vinyl, pewter, acrylic, ceramic, nickel, and all other metal alloys. The most preferred material for making a utensil arm lock is injection molded plastic.

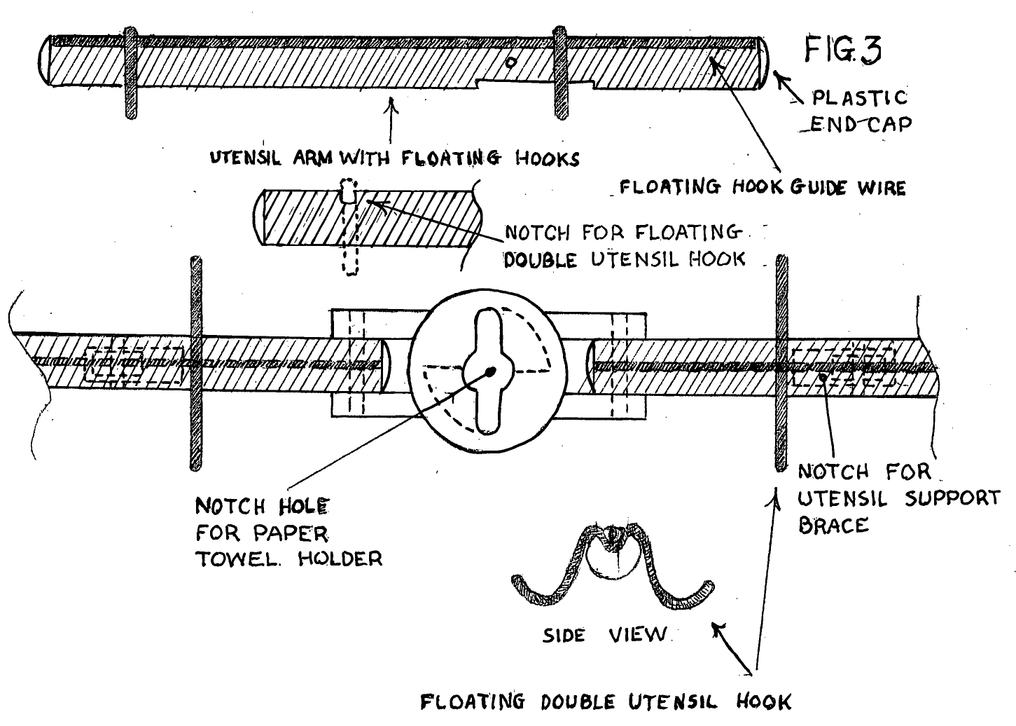

FIG. 3/8 shows in more detail the utensil arm with floating utensil hooks. The floating double utensil hooks are two (2) hooks made of one piece of wire bent in a way as to fit into a notch that is cut into the top side of the utensil arm. The down-curved part between the two hooks fits into the notch and a wire (made of stainless steel like the floating double utensil hook) is called the floating hook guide wire.

The floating hook guide wire is inserted into the end of the utensil arm and placed between the inside channel of the utensil arm and the down-curved part of the floating double utensil hook, holding the floating double utensil hook in place while allowing a small amount of movement to help reduce shock on the utensil arm.

FIG. 3/8 also shows plastic caps at the ends of the utensil arm that hold the floating hook guide wire in place as well as adding a finished look to the utensil arm.

The utensil arm has a notch cut into the bottom to allow the insertion of the end of the utensil arm support brace inside the utensil arm to provide unobstructed clearance around the floating double utensil hook area.

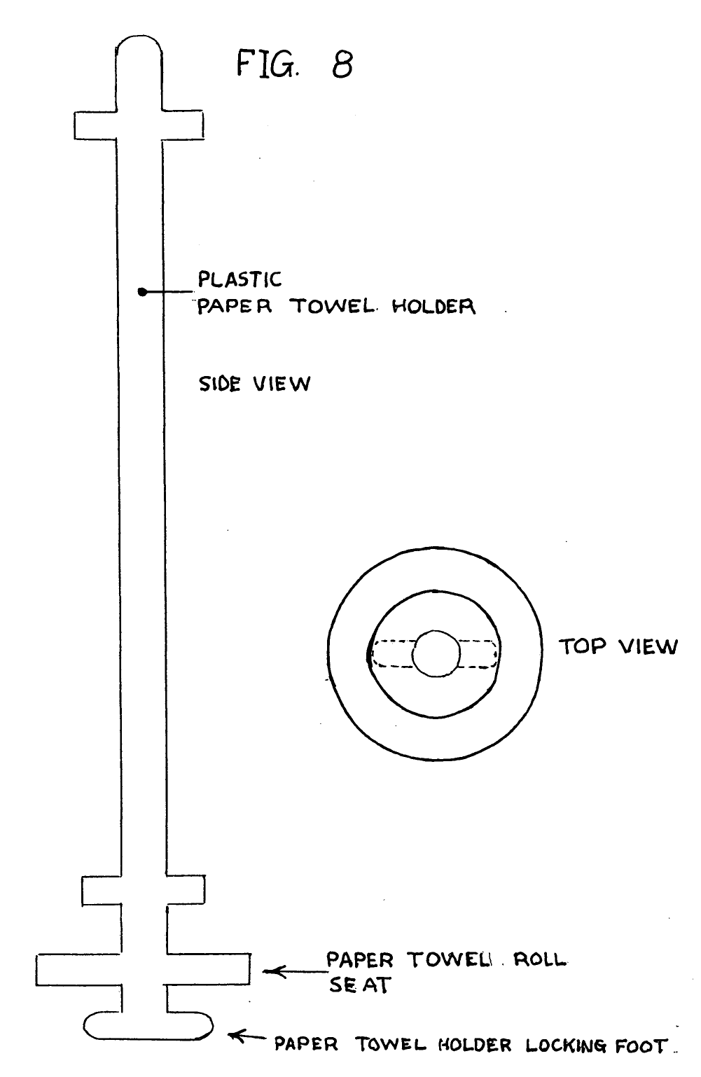

Also from FIG. 3/8 we can gain insight into the notch hole in the top side of the center support head designed for the insertion of the paper towel holder seen in FIG. 8/8. The paper towel holder will be described later in more detail.

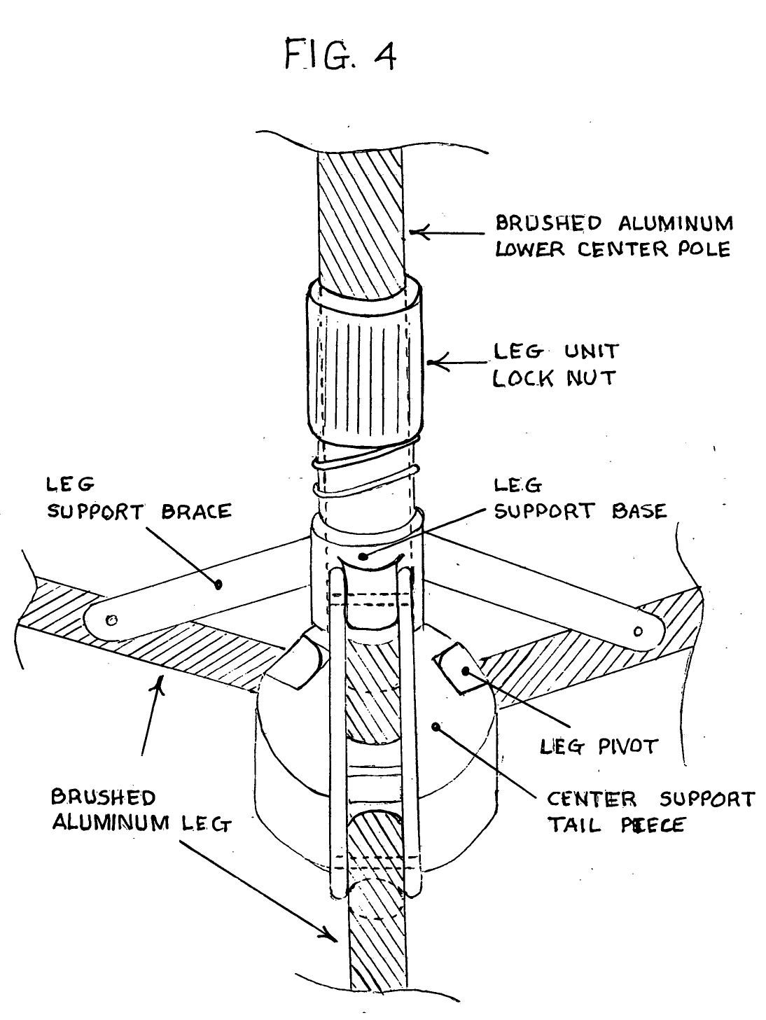

FIG. 4/8 describes the parts required to make the lower end, or the foot, of the “Outdoor Cooking Helping Hand.”

The center support tailpiece is the anchor of the entire lower end of this unit. The preferred materials for making a center support tail piece are steel, stainless steel, aluminum, brass, copper, glass, pot metal, lead, wood, vinyl, pewter, acrylic, ceramic, nickel, and all other metal alloys. The most preferred material for making a center support tailpiece is injection molded plastic.

Connected directly to the center support tailpiece by bi-metal rivets are the leg pivots. The preferred materials for constructing the leg pivots are steel, stainless steel, aluminum, brass, copper, glass, pot metal, lead, wood, vinyl, pewter, acrylic, ceramic, nickel, and all other metal alloys. The most preferred material for constructing the leg pivot is injection molded plastic.

The legs of the stand are connected to the leg pivots. The preferred construction of the utensil stand base can be with two, four, or five legs with or without a round weighted base with a flat bottom or a square weighted base, a cup driven into the ground to stand the utensil stand in, wheeled base, or any combination thereof. The most preferred utensil stand base construction is three legs.

The preferred materials for construction of the utensil stand legs are steel, stainless steel, injected molded plastic, PVC pipe, brass, copper, glass, pot metal, lead, wood, vinyl, pewter, acrylic, ceramic, nickel, and all other metal alloys. The most preferred material for the utensil stand legs is brushed aluminum tubing.

The brushed aluminum legs have a plastic cap at the end of each leg for strength and to provide a finished look.

Connected to the brushed aluminum legs are leg support braces. The connection is made with bi-metal rivets for flexibility. The preferred materials for constructing a leg support brace are steel, stainless steel, aluminum, brass, copper, glass, pot metal, lead, wood, vinyl, pewter, acrylic, ceramic, nickel, and all other metal alloys. The most preferred material for the leg support braces is injection molded plastic.

The leg support brace is connected to the leg support base with bi-metal rivets for strength and flexibility for folding. The leg support base is a sleeve that slides up and down, allowing the legs to be opened and closed as needed. The preferred materials for construction of the leg support base are steel, stainless steel, aluminum, brass, copper, glass, pot metal, lead, wood, vinyl, pewter, acrylic, ceramic, nickel, and all other metal alloys. The most preferred material for the leg support base is injection molded plastic.

The lower center pole is the main support of the entire lower body of the utensil hanger unit. The preferred materials for construction of the lower center pole are steel, stainless steel, injection molded plastic, PVC tube, brass, copper, glass, pot metal, lead, wood, vinyl, pewter, acrylic, ceramic, nickel, and all other metal alloys. The most preferred material for the lower center pole is brushed aluminum tubing.

Upon opening or closing the pieces that comprise the lower leg unit, they are locked into place by the leg unit lock nut. When the leg unit is moved to the desired position the leg unit lock nut is turned clockwise to lock it into place.

The preferred materials for construction of a leg unit lock nut are steel, stainless steel, aluminum, brass, copper, glass, pot metal, lead, wood, vinyl, pewter, acrylic, ceramic, nickel, and all other metal alloys. The most preferred material for the leg unit lock nut is injection molded plastic.

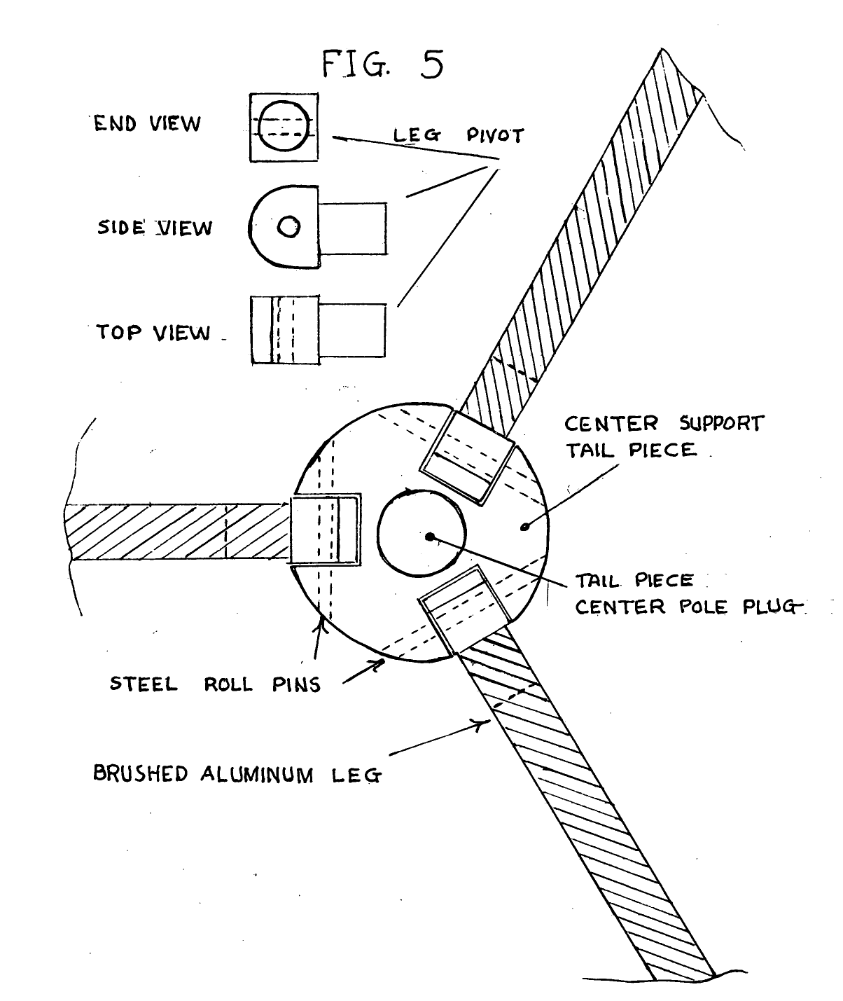

FIG. 5/8 is a top view of the leg unit. The center support tailpiece supports a tailpiece center pole plug. This plug is inserted into the bottom of the lower center pole to add strength and make the lower leg unit more rigid. The use of steel roll pins in the leg pivots adds a great deal of strength to the entire lower unit.

FIG. 5/8 also illustrates the design of the leg pivots.

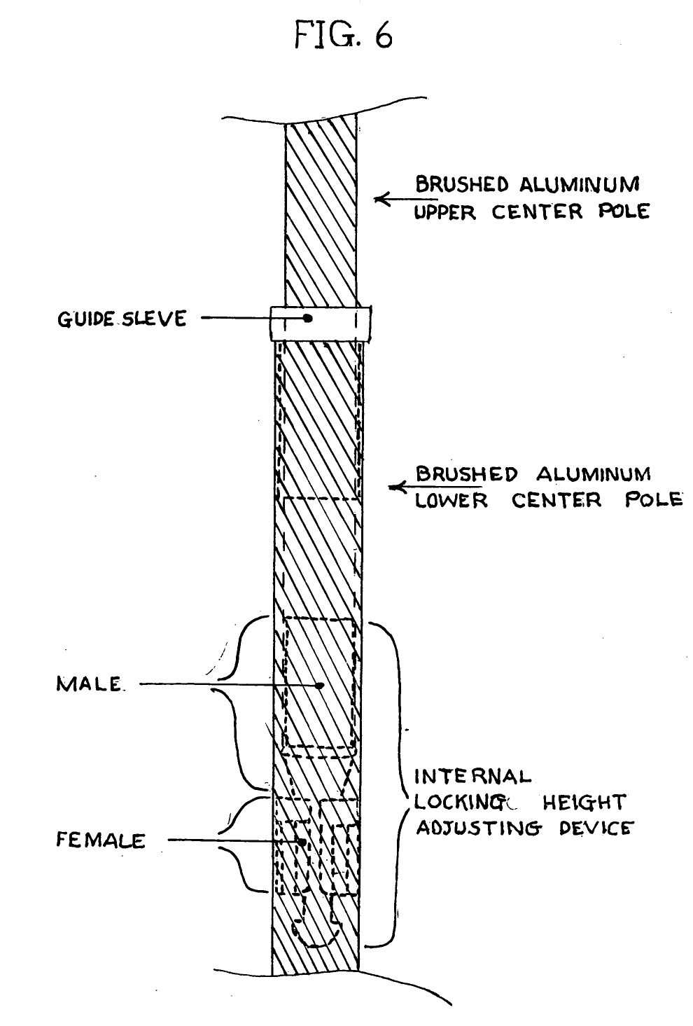

FIG. 6/8 shows a side view of the internal locking height adjusting device as well as the guide sleeve that ensures a smooth flow of movement when adjusting the height of the center poles.

The operation of the internal locking height adjusting device is achieved by grasping the lower center pole in one hand and the upper center pole in the other hand, then twisting counterclockwise to loosen the internal locking height adjusting device. After adjusting the unit to the preferred height the poles are then twisted clockwise to lock them at that height.

Preferred materials for construction of the internal locking height adjusting device are steel, stainless steel, aluminum, brass, copper, glass, pot metal, lead, wood, vinyl, pewter, acrylic, ceramic, nickel, and all other metal alloys. The most preferred material for the internal locking height adjusting device is injection molded plastic.

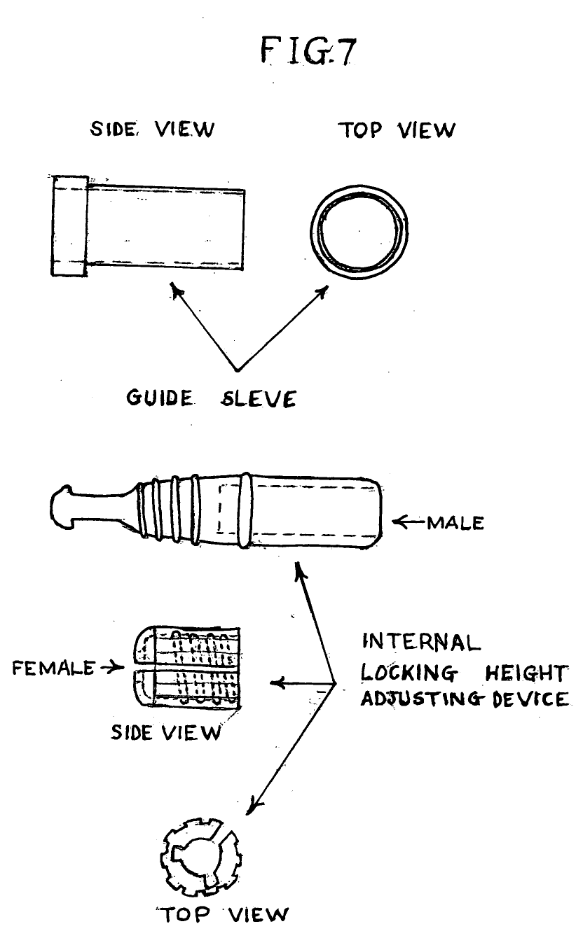

FIG. 7/8 illustrates a sectioned view of the internal locking height adjusting device. The male section of the internal locking height adjusting device fits snugly into the end of the of the brushed aluminum upper center pole and, when twisted, threads either in or out depending on the direction of the twist. When twisted clockwise the male threaded end threads deeper into the female part and expands it, locking the upper and lower brushed aluminum poles at the desired height. Twisting the threads counterclockwise unthreads the male end out of the female part, loosening the upper and lower brushed aluminum poles, thus allowing the height to be adjusted.

FIG. 8/8 is the paper towel holder, which is designed to sit on top of the center support head. It is held in place by inserting the paper towel holder locking foot into the center support head notch hole (FIG. 3/8) and twisted clockwise to lock it into place. The plastic paper towel holder has a paper towel roll seat at the bottom for the roll of paper towels to sit on.

The preferred materials for construction of the paper towel holder are steel, stainless steel, aluminum, brass, copper, glass, pot metal, lead, wood, vinyl, pewter, acrylic, ceramic, nickel, and all other metal alloys. The most preferred material for the paper towel holder is injection molded plastic.

### OBJECTIVES

The objectives of this invention, the “Outdoor Cooking Helping Hand”, are many fold and ultimately combine to make the whole of the utility stand.

The objectives of this invention are to produce a utility stand that:
Is compact for the ease of transport and storage.
Provides paper towels at the cooking site with a convenient paper towel holder designed into the utility stand.
Has folding three-legged stand that makes it more stable on rough and uneven outdoor surfaces.
Has two unique folding arms that have a total of eight (8) hanging hooks to facilitate hanging and retrieval of cooking utensils.
Is a lightweight, strong, and durable product with a height adjustment allowing the utensil height to be raised or lowered depending on situational needs.
Helps keep cooking utensils organized and ready at hand for outdoor cooking, as well as to help keep the utensils clean for food preparation.

1. I, David P. Law, do hereby claim the Outdoor Cooking Helping Hand to be a portable, lightweight, freestanding outdoor cooking utensil holder that provides organization of the cooking utensils and convenient access not only to the cooking utensils but also to paper towels. It can be adjusted to a proper height to suit the individual using it and is extremely portable.
